(19) United States
(12) Patent Application Publication
(10) Pub. No.: US 2018/0261087 A1
(43) Pub. Date: Sep. 13, 2018

(54) Traffic Signal String SuperMode Control Method

(71) Applicant: Weiping Meng, Flushing, NY (US)

(72) Inventor: Weiping Meng, Flushing, NY (US)

(21) Appl. No.: 15/916,231

(22) Filed: Mar. 8, 2018

(30) Foreign Application Priority Data
Mar. 9, 2017 (CN) 201710137495.6

(51) Int. Cl. G08G 1/083

(52) U.S. Cl. CPC G08G 1/083

(57) ABSTRACT

The invention relates to a traffic signal mode field, discloses a method for a supermode of traffic signal control: String Supermode, its main steps includes: 1)get String Supermode instruction; 2)set the basic parameters of String Supermode: subareas of a roadnet, period-redistribution; 3)set 2D greenwave mode in the relative subareas according to a String Supermode structure; 4)calculate the 2D greenwave time-offsets and their interim-period in each subarea; 5)run new mode after the above interim-period run out. The present invention realizes the effectiveness of signals equilibrium, high effieciency, multi-purpose, universe, easy to use: vehicles entering Wormhole-area from any direction and going to any position of the diagonal far-corner area, need 4.5 times of red lights on average, no matter how large a Wormhole-class controlled area and how big the number of intersections in the area are, multiple-class-change based on Wormhole-class presents the functions of the fast inhalation of vehicle flow from omni-direction, :the fast spitting out of vehicle flow to omni-direction, the relieving jammed vehicle flow during spitting out to omni-direction, the relieving jammed vehicle flow during inhalation from omni-direction, the coordinating artery roads to quickly shunting vehicle flow, and also, the vehicles' going through an area by only 1 red light of Pulsar-class; this String Supermodes are determined by only about 20 of parameters, can switch rapidly with no redundance, provide an area-type traffic control, analysis, operation basic mode.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to a method for traffic control, particularly to traffic signal network String SuperMode control method.

Metropolitan traffic signals control methods including area-control currently mainly rely on artery-coordination control technology, which is the results of the interactions of city's evolution and technology's development. Artery-type greenwaves enables “vehicles follows the green wave going to the unlimited end of this waves”, which indeed solved the RATIO mode's problem that a green light permits vehicles to move at most such a distance that is set-drive-speed multiplied by the time of the green light, is suitable very well for cities with the moderate quantity of vehicles. Modern metropolises are full of vehicles everywhere, including non-artery roads also filled fully with vehicles, only in artery roads vehicles' running smoothness is not capable of meeting the needs of the reality, causes the problems: running smooth and fast in an artery roads=>vehicles inflows into the artery roads=>artery road jam full of vehicles, which has become a modern traffic chronic illness. Traffic optimization based on linear greenwave technology needs coordinates many many factors, whose process are often very complicated, often “care for this and lose that”, obtains no obvious effectiveness, even though since 1970's under the background of the emergence of many intelligent methods, the development of traffic signal control technology is still in an awkward predicament of almost staying. The basic operations of “Artery-type greeenwave” does not offer cross-directions high efficiency traffic control, forces area-type traffic to concentrate to artery-type traffic, produces its-tech-inherent congestion, not suitable for large area-type traffic requirements, not easy to intelligentize the control, and the reality needs new universal signal modules. Recently the methods for 2 cross-directions greenwave Lead mode has been proposed, which extends the linear green wave that traffic follows the wave to infinite end to an area greenwave that runs two cross directions' groups of greenwave channels, and also traffic Jam-Relief modes has been disclosed, the problem of smooth switch between signal modes and greenwaves has been solved with new designed real time moding method. A universal signal mode of equilibrium, high efficiency and multipurpose has become an important realistic demand for traffic signal control.

### BRIEF SUMMARY OF THE INVENTION

It is an object of the present invention to design the universal signal mode of equilibrium, high efficiency and multipurpose.

The main idea of the present invention providing a solution to achieve the above object is, new invented two dimensional greenwave modes as basic modules are combinated in certain number of them and certain way, a kind of super signal module, supermode, is constructed; the number and the way are determined in such a way: at price of slightly limiting the unlimited transfer function of the two dimensional greenwave module, for the purpose of minimizing the energy consumption of system itself and minimizing the loss of efficiency, determine the combinatory way and number of the modules used in order to obtain the performance of equilibrium, high efficiency and multipurpose; because it is founded in the greenwave generated by the alternative change of red and green signals, it seems those “strings” which vibrates, generates out wave and construct everything everywhere in universe, so named as a String SuperMode. The features are as follow:

A method for a String SuperMode used in road traffic signal network includes steps:

S1: Set RATIO as initial state with obtaining the length and traffic-times of every road-segment of a roadnet;

S2 calculate and configure new String Supermode according to a String Supermode instruction: 1) set the basic parameters: 1.1) divide the roadnet area of intersections into several subareas, 1.2) or redistribute period and speed limit according to the features of road-segments, 1.3) or equip signal devices for limit speed, countdown timer, change-speed including guideboard, vehicle navigator, mobile communication equipment or autopilot system, etc; 2) configure the 2D mode of greenwave in each said subarea of the String Supermode structure, said 2D mode of greenwave including IDEN-Lead mode, IDEN-Jam-Relief mode, DIFF mode, etc, the combination of the origins' positions and their master directions of 2D mode in said subareas determine the class of String SuperModes, vice-verse, 2.1) determine the position of the origin of instructed 2D mode of every subarea: an intersection at a corner in a subarea, \textcircled{1} determine master/slave directions, \textcircled{2} determine Lead/Jam-Relief greenwave, \textcircled{3} get the position of an origin and the configuring channels of 2D greenwave time-offsets and their strat-intersections: for 2D Lead mode of greenwaves, i.e. IDEN-Lead mode, its origin is the intersection of the most upstream intersection both of master direction and of slave one, the start-intersection from where every master direction channel's every intersection's greenwave time-offset is calculated is its channel most upstream intersection, the configuring channel of slave greenwave time-offsets is composed of the start-intersections of master direction channels and its start-intersection is the above origin; for 2D Jam-Relief mode of greenwaves, i.e. IDEN-Jam-Relief mode, its origin is the intersection of the most downstream intersection both of master direction and of slave one, the start-intersection from where every master direction channel's every intersection's greenwave time-offset is calculated is its channel most downstream intersection, the configuring channel of slave greenwave time-offsets is composed of the start-intersections of master direction channels and its start-intersection is the above origin; for 2D Lead and Jam-Relief mode of greenwaves, i.e. DIFF-mix mode, its origin is the intersection both of the most upstream intersection of Led direction and of the most downstream intersection of Jam-Relieved direction, the start-intersection from where every led direction channel's every intersection's master greenwave time-offset is calculated is its channel most upstream intersection, the configuring channel of slave greenwave time-offsets is composed of the start-intersections of master direction channels and its start-intersection is the above origin, and for 2D Jam-Relief and Lead mode, i.e., the master-Lead direction and slave-Jam-Relief exchange of DIFF-mix mode: and also the master-Jam-Relief direction and slave-Lead direction; 2.2)calculate the greenwave time-offsets of every intersection and configure its interim period: \textcircled{1} determine the traffic-time of the time-offsets of every road-segment, Lead mode uses set-drive-times to sum, Lead mode uses JVQ-start-times to sum, \textcircled{2} calculate the time-offset t1 from its start-intersection of every intersection of a master channel, \textcircled{3} calculate the time-offset t2 from the origin intersection of every intersection of the slave time-offset configuring channel, \textcircled{4} add master time-offset t1 and slave tie-offset t2, get 2D mode time-offset t, \textcircled{5} obtain the period remainder of the 2D mode time-offset t, \textcircled{6} make the period remainder a signal interim period of every intersection: the remainder as time=North-South permit time+East-West permit time;

S3 run RATIO mode after running out the respective interim period of every intersection with red-light-on or without signals;

Another feature of the present invention is that the 1.1) of step S2 includes steps of:

S21 using straight lines divide a roadnet area of intersections into some subareas, obtain following types: 4 areas of [symbol] -type of [symbol] -division, [symbol] -type division, [symbol] -type division and [symbol] -type division, [symbol] -type division/ [symbol] -type division, etc, these divisions generally corresponds to the distributions of the intersections of a real roadnet, also to the configuration by softwares for the requirements of controlling traffic flows of roadnets, [symbol] -type of [symbol] -division is standard String Supermode division, is a basic optimized structure, absolute symmetry is not a must.

Another feature of the present invention is that step S2 includes steps of:

S22 said signal devices of showing to moving vehicles for limit speed, countdown timer, change-speed include guideboard, vehicle navigator, mobile communication equipment or autopilot system, etc, showing information includes the rest signal time, approaching minimum braking point/time/reducing speed, showing way includes words, phonetics, colors, patterns, etc., signals includes red lights or green lights; for an example, the time <5 of signals countdown timer, limit speed 36km/h, its braking time/distance are 3 sec/15 meters or so, at about 20 meters show the information for reducing speed, in words, phonetics, colors, patterns, etc., signals includes red lights or green lights ;

Another feature of the present invention is that step S2 includes steps of:

S23 Configure a class called Wormhole of Said String Supermode from a String Supermode instruction: 1) divide a roadnet area using straight lines, obtain subareas, each of which subareas and their mother roadnet area share one and only one side; 2) configure each subarea as such a IDEN-Lead mode that its origin is at a side but not at a corner of the roadnet, and its master directions of subareas are organized clockwise rotation, called Right rotation Wormhole of String, and organized anticlockwise rotation, called Left rotation Wormhole of String;

Another feature of the present invention is that step S2 includes steps of:

S24 Configure a class called Blackhole of Said String Supermode from a String Supermode instruction: 1) divide a roadnet area using straight lines, obtain subareas, whose mother roadnet area and each of which subareas have one and only one side to share; 2) configure each subarea as such a IDEN-Lead mode that its origin is at both a corner of the subarea and a corner of the roadnet, and its master directions of subareas are organized clockwise rotation, called Right rotation Blackhole of String, and organized anticlockwise rotation, called Left rotation Blackhole of String;

Another feature of the present invention is that step S2 includes steps of:

S25 Configure a class called Whitehole of Said String Supermode from a String Supermode instruction: 1) divide a roadnet area using straight lines, obtain subareas, each of which subareas and their mother roadnet area share one and only one side; 2) configure each subarea as such a IDEN-Lead mode that its origin is neither at a side nor at a corner of the roadnet, and its master directions of subareas are organized clockwise rotation, called Right rotation Whitehole of String, and organized anticlockwise rotation, called Left rotation Whitehole of String;

another feature of the present invention is that step S2 includes steps of:

S26 Configure a class called Redgiant of Said String Supermode from a String Supermode instruction: 1) divide a roadnet area using straight lines, obtain subareas, each of which subareas and their mother roadnet area share one and only one side; 2) configure each subarea as such a IDEN-Jam-Relief mode that its origin is both at a corner of a subarea and at a corner of the roadnet, and its master directions of subareas are organized clockwise rotation, called Right rotation Redgiant of String, and organized anticlockwise rotation, called Left rotation Redgiant of String;

Another feature of the present invention is that step S2 includes steps of:

S27 Configure a class called Whitedwarf of Said String Supermode from a String Supermode instruction: 1) divide a roadnet area using straight lines, obtain subareas, each of which subareas and their mother roadnet area share one and only one side; 2) configure each subarea as such a IDEN-Jam-Relief mode that its origin is neither at a side nor at a corner of the roadnet, and its master directions of subareas are organized clockwise rotation, called Right rotation Whitedwarf of String, and organized anticlockwise rotation, called Left rotation Whitedwarf of String;

another feature of the present invention is that step S2 includes steps of:

S28 Configure a class called Centipede of Said String Supermode from a String Supermode instruction: 1) divide the roadnet mother area through with a straight line, obtain 2 subareas; 2) configure each subarea as such a IDEN-Lead mode that one of the 2 origins is at a corner of a subarea and a side of but not a corner of the roadnet, and the 2 origins are adjacent or opposite at the other end of the master channels whose one end is adjacent to the other origin, make the single master direction or 2 convection master directions, organized so-called Shunting Centipede of String, 2 adjacent origins can share one intersection; or, that the both origins are separately at a non-adjacent corner of the roadnet, organized so-called Conflux Centipede of String;

another feature of the present invention is that step S2 includes steps of:

S29 Configure a class called b-Pulsar of Said String Supermode from a String Supermode instruction: 1.2) configure a Convection IDEN-Lead mode greenwave period: 1.2.1)configure the said mode whose maximum convection mode loss λ max is less than some percentage (1-b) %: max is the maximum absolute difference between a road-segment's set-drive-time and the average D of all road-segment's set-drive-times divided by the average D,.take the average time T of the set-drive-time in λ max<(1-b) %, T=D/v, v-set-drive-speed(meter/sec); 1.2.2)according to the average T that meets the error requirement λ max<(1-b) %, determine the period C=2*T;

Another feature of the present invention is that the 1.2.1) of b-Pulsar includes steps of:

S210 configure maximum convection mode loss λ max less than some percentage (1-b) %: \textcircled{1} calculate the λ max, and T: λ max= [symbol] Tmax/T= [symbol] Dmax/D, where [symbol] Tmax—the longest road-segment's set-drive-time minus the average drive-time, [symbol] Dmax—the longest road-segment minus the average road-segment, T—the average set-drive-time of all road-segments, T=D/v, D—the average length of all road-segments(meter)=(Σdk)/n, dk—the k-th road-segment length, v—set-greenwave-drive-speed, n—total number of road-segments including row-channels and column-channels, for a roadnet {M,N}, n=M*(M−1)+N*(N−1), \textcircled{2} if λ max is bigger than (1-b) %, then group road-segments based on the lengths' similarity degree of road-segments, if the average length of a group and the one of another group are integer multiples, based on \textcircled{1} calculate an equavilent length of the longer group first, then obtain λ max and its T, \textcircled{3}, if the average lengths of groups are not around integer multiples, design variable set-greenwave-drive-speed scheme: set a different set-greenwave-driv-speed v for each group of road-segments, calculate and configure λ max and its T;

Said traffic-time is set-drive-time or JVQ-start-time: said set-drive-time equals to drive time driving at set-drive-speed of a road-segment through the segment, said JVQ-start-time equals to JVQ-start-coefficient*jam-coefficient*jammed road-segment-length*apart-coefficient, where the jam-coefficient is less than or equals to one, “equals to one” means heavy jam , the apart-coefficient is bigger than or equals to one, “equals to one” means keeping present status, “bigger than one” makes the vehicle queue apart from each other;

Said jammed queue-length minus the length of the traffic upstream intersection with no vehicles, and multiplied by a number less than one;

Said jammed queue-length plus the length of the traffic upstream intersection fully occupied with vehicles;

Said set-drive-time minus the brake-time of set-drive-speed;

The advantages of the present invention are below: 1) equilibrium: its Wormhole-class provides entrance/exit channels in East/West/South/North omni-direction, inhaling and spiting out at same time; 2) high efficiency: when vehicles enters a Wormhole-area from any direction of East/West/South/North and go to any position of the diagonal far-corner area, meet 4.5 times of red lights on average, when following the rotating direction of a Wormhole-class, vehicles meet red light times on average of (0.5+1.5+4.5+7.5)/4=14/4=3.5 times, when going in the anti-rotating direction of a Wormhole-class, during every green light vehicles go through intersections on average of such numbers that often is not less than the numbers for vehicles to go through in the non-controlled direction of Linear-Artery-type, no matter how large a Wormhole-class controlled area and how big the number of intersections in the area are, even in a 50×50 kilometer span of 40 thousand intersections it also holds, meanwhile for the Linear-Artery-type technology used in the same number and distribution of intersections with 8 directions' entrances of 2 optimal subareas, the average times of meeting red light (0.5+2.5+n/4)/2=n/8+1.5, is a function of total intersections in the area, i.e., Wormhole-class provides faster entrance/exit in omni-direction, the larger the n, the more obvious this advantage; 3) universal: because of the equilibrium and high efficiency, applicable to any scale of intersections area, good for metropolis, super-metropolis or industrial zone/commercial zone, the entrances/exits of the greenwave channels in every direction are adjustable dynamically in order to response to the traffic change, additionally, the multiple variations from [symbol] -type enables itself applicable to many different real distributions of intersections groups; 4) multipurpose: multiple-change based on Wormhole-class, presents the multipurpose: such as the Blackhole-class that is special at fast inhalation of vehicle flow from omni-direction, the Whitehole-class that is special at fast spitting out of vehicle flow to omni-direction, the Redgiant-class that is special at relieving jammed vehicle flow during spitting out to omni-direction, the Whitedwarf-class that is special at relieving jammed vehicle flow during inhalation from omni-direction, the Centipede-class that is special at conflux vehicle flow to or shunting vehicle flow from artery road, from the 2 wing directions of the artery road, which improves the efficiency of the artery-type roadnet, the Pulsar-class that enables for vehicles going through or to any position in the area from any direction to need only 1 red light, comparing with the corresponding values n/4+2.5 of two-way-interactive mode with same intersections and same distribution, shows a lot of excellence, more suitable for new planned zone, in addition, many combination of 2D greenwave mode for the String Supermode are not presented directly here, such as DIFF-mix modes, etc.; 5) easy to be used in advanced intelligent method: its analysis, decision, configuration and running are simple, described on 20 or so independent parameters, which parameters actually is the dimension of controllable multiple-change space of the String.

### BRIEF DESCRIPTION OF THE DRAWINGS

FIG. 1 is a flowchart of traffic signal String Supermode control method;

FIG. 2 is a roadnet running a [symbol] -type Left-Rotation Wormhole of String Supermode;

FIG. 3 is a roadnet with a [symbol] -type Right-Rotation Blackhole and Set of String Supermode;

FIG. 4 is a roadnet with a [symbol] -type Left-Rotation Whitehole and Set of String Supermode;

FIG. 5 is a roadnet with a [symbol] -type Left-Rotation Redgiant and Set of String Supermode;

FIG. 6 is a roadnet with a [symbol] -type Right-Rotation Whitedwarf and Set of String Supermode;

FIG. 7 is a roadnet with a [symbol] / [symbol] -type Shunting Centipede and Set of String Supermode;

FIG. 8 is a roadnet with a 85-Pulsar and Set of String Supermode;

### LIST OF REFERENCE NUMERAL UTILIZED IN THE DRAWING

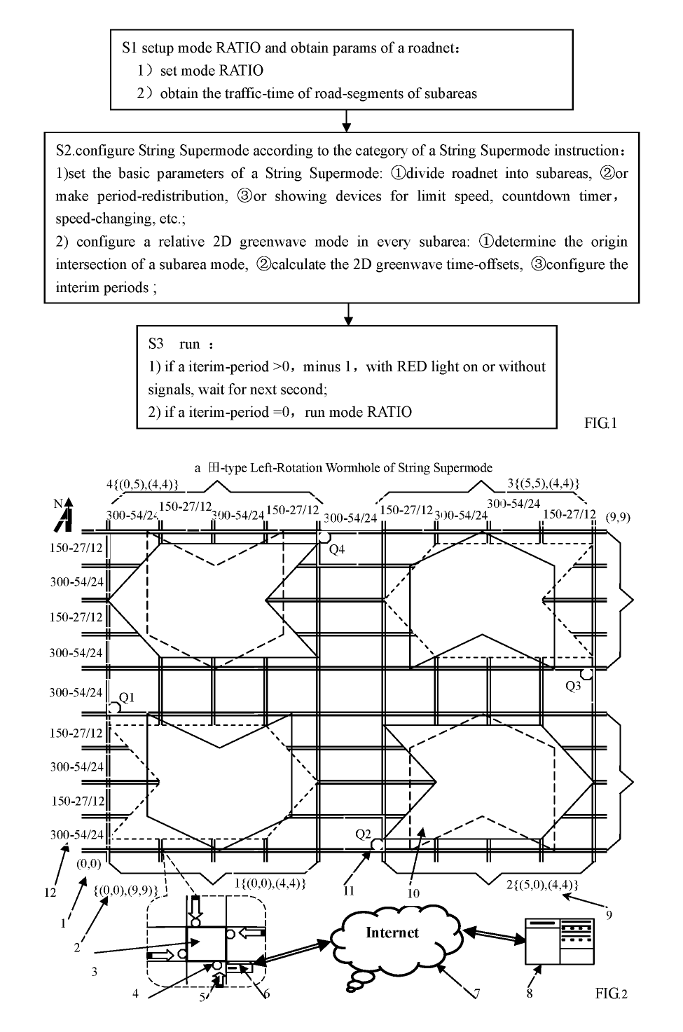

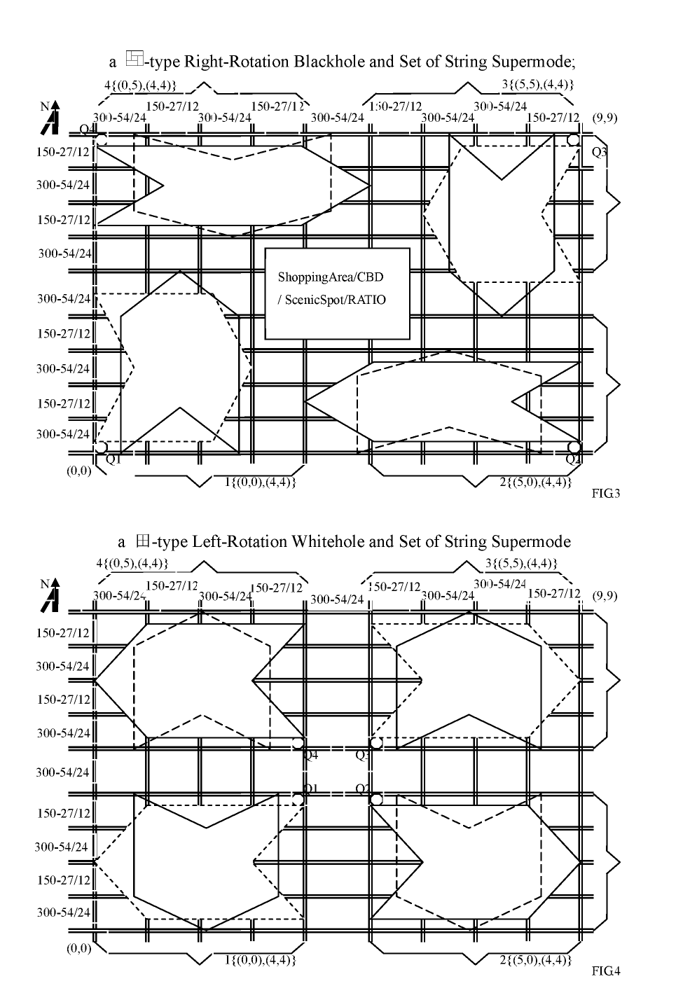

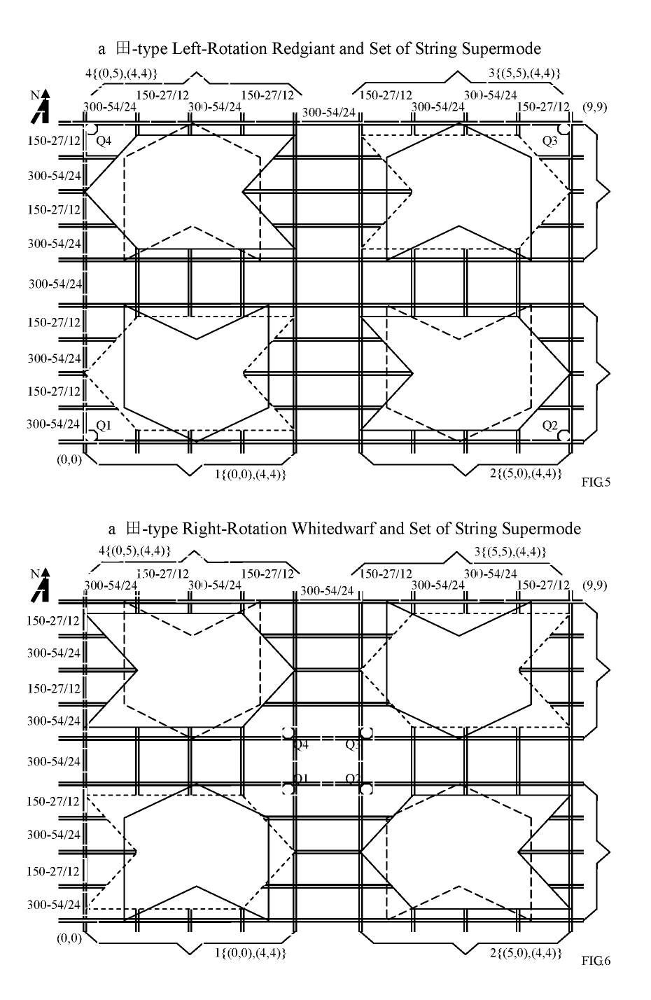

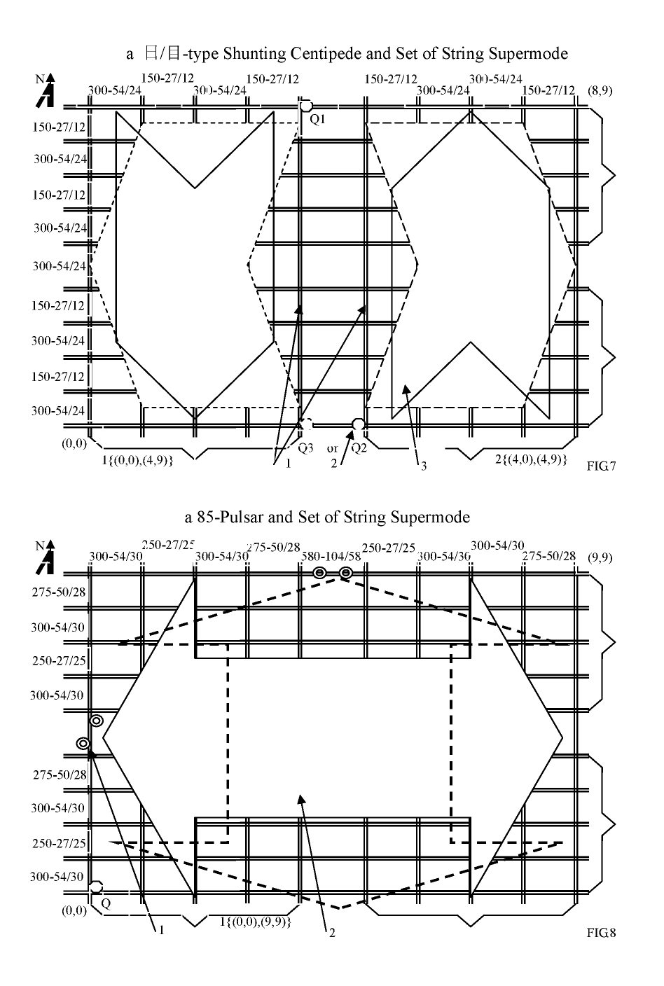

FIG. 2: a Left-Rotation Wormhole of String Supermode controlling a roadnet that is divided by “ [symbol] ” lines into 4 subareas, the origins of 4 IDEN-Lead modes are Q1(0,5), Q2(5,0), Q3(9,5), Q4(4,9); 1—at the lower-left corner, the origin intersection coordinates (0,0) of a roadnet; 2—roadnet mark {(0,0),(9,9)}, for the origin coordinates (0,0), the maximum and minimum coordinates (9,9) of row and column are 9 each; 3—intersection; 4—traffic signals; 5—vehicle queue; 6—traffic signals controller; 7—internet; 8—control system center; 9—subarea mark 2{(5,0),(4,4)}, for the number 2 area, its origin coordinates (5,0), the maximum and minimum coordinates (4,4) of row and column are 4 each; 10—master direction and its channel greenwave direction signed with solid line hollow arrow pointing at East-Right, slave greenwave direction signed with dotted line arrow; 11—the origin of IDEN-Lead mode marked as Q and small octagon and its coordinates(5,0); 12—“#-#/#” is for three values: distance between two adjacent intersections—JVQ-start-time/set-drive-time, unit: meter—second/second; hereinafter follow the above;
FIG. 3: a Right-Rotation Blackhole of String Supermode controlling a roadnet that is divided into 4 subareas of [symbol] -type, the origins of 4 IDEN-Lead modes are Q1(0,0), Q2(9,0), Q3(9,9), Q4(0,9), where surrounded by the 4 subareas in the center is a zone that may be a sightseeing zone/pace zone/commercial zone/non greenwave {(4,4),(2,2)} signals zone;
FIG. 4: a left-Rotation Whitehole of String Supermode controlling a roadnet that is divided into 4 subareas of [symbol] -type, the origins of 4 IDEN-Lead modes are Q1(4,4), Q2(5,4), Q3(5,5), Q4(4,5);
FIG. 5: a left-Rotation Redgiant of String Supermode controlling a roadnet that is divided into 4 subareas of [symbol] -type, the origins of 4 IDEN-Lead modes are Q1(0,0), Q2(9,0), Q3(9,9), Q4(0,9);
FIG. 6: a Right-Rotation Whitedwarf of String Supermode controlling a roadnet that is divided into 4 subareas of [symbol] -type, the origins of 4 IDEN-Lead modes are Q1(4,4), Q2(5,4), Q3(5,5), Q4(4,5);
FIG. 7: a left-Rotation Shunting Centpede of String Supermode controlling a roadnet that is divided into subareas of [symbol] / [symbol] -type, the origins of 2 IDEN-Lead modes are Q1(4,9), Q2(5,0), 1—master direction artery road; 2—the origin Q2 of the IDEN-Lead mod of right subarea, its master direction Down-South and its opposite direction Up-North in its left adjacent subarea; 3—dotted line arrow is slave direction East, West to shunt, solid line arrow is master direction Down-South, Up-North; the Q3 at bottom and dotted line octagon is another configuring origin for the left subarea which combines with Q2 forming single master direction artery road;
FIG. 8: a 85-Pulsar of String Supermode controlling a roadnet that the origins of the IDEN-Lead mode are Q1(0,0), 1—small double circle is for showing and reminding device of greenwave limit speed and speed adjust; 2—the double direction arrows for convection greenwaves, solid line for master direction, dotted line for slave direction;

### DETAILED DESCRIPTION OF THE INVENTION

### Description of the Preferred Embodiments, Industry Applications

Detailed description of three embodiments of the invention in conjunction with the accompanying drawings:

As FIG. 1, Traffic signal String Supermode control method, which is implemented into the control software of traffic control center system as label 8 in FIG. 2, executes S1 initial configuration 1) set RATIO for the traffic signals controller as label 6 in FIG. 2 of every intersection as label 3 in FIG. 2 in the roadnet as label 2 in FIG. 2: signal period 60 seconds, South-North direction and East-West direction each 30 seconds, Straight phase 20 seconds, Left phase 10 seconds, then, 2) obtain the length and traffic-time of every road-segment, etc., as labels in FIG. 2, the feature parameters of the roadnet; S2 configure new String Supermode according to a mode-instruction: 1)set basic parameters of String Supermode: 1.1) divide the roadnet area into several subareas, 1.2) or redistribution of the period, limit speed based on the above features, 1.3) or set showing devices for limit speed, countdown timer, change-speed including guideboard, vehicle navigator, autopilot system, mobile phone, etc, 2) configure the corresponding 2D greenwave mode in every subarea, including IDEN-Lead mode, IDEN-Jam-Relief mode, DIFF-mix mode, etc.: 2.1) determine the origin position of the corresponding 2D greenwave mode in each subarea: master/slave direction, Lead/Jam-Relief function, the channels and their start-intersections of master/slave direction time-offset setting, 2.2) calculate the time-offsets and its interim period of every intersection of every subarea of corresponding 2D greenwave mode and configure the interim period; S3 run: run out the String Supermode's interim period first, then run RATIO mode. The following are the detailed step S2 for configuring a Wormhole-classs as FIG. 2, a Centipede-class as FIG. 7, a Pulsar-class of 3 embodiments of String Supermode.

As in FIG. 2, the features of a roadnet included: the coordinates(0,0) as label 1 of the origin intersection at the lower left corner of roadnet {(0,0), (9,9)} as label 2 or roadnet{7,5}, which has a total of 35 intersections, 7 North-South col.-D-channels and 5 East-West row-D-channels, the set of the traffic-time of the col-D-channels Col. {7,4}{==}, for 28 corresponding North-South road-segments, the set of the traffic-time of the row-D-channels Row{5,6}{==}, for 30 corresponding East-West road-segments of the row-D-channels, the “#-#/#” as label 12 for length #—its JVQ-start-time #/its set-drive-time # of each road-segment, unit:meter—second/second, where the JVQ-start-time=JVQ-start-coefficient*jam-coefficient*road-segment-length*apart-coefficient, wherein jam-coefficient is less than or equal to 1, “equal to 1” means heavy jam, apart-coefficient is bigger than or equal to 1, “equal to 1” means keeping-the-present-status, JVQ-start-coefficient based on experimental estimate ranges 0.14˜0.22, taking their median 0.18, letting jam-coefficient=1, heavy jam, vehicle-queue-length=road-segment-length under heavy-jam, and apart-coefficient=1, keeping-the-present-status, ignoring the length of an intersection, therefore, JVQ-start-time=road-segment-length*0.18, wherein set-drive-time is calculated based on set-drive-speed=45 kilometers/hour, for an example, the length between intersection(3,0) and intersection(4,0) is 150 meters, its JVQ-start-time 27 secs/its set-drive-time 12 secs, the length between intersection(4,2) and intersection(4,3) is 300 meters, its JVQ-start-time 54 secs/its set-drive-time 24 secs, thus, the set of the traffic-times of the road-segments of row D-channels from row 1{==} to row 10{==} are {54/24,27/12,54/24,27/12,54/24,27/12,54/24,/54/24,27/12}, the set of the traffic-times of the road-segments of column D-channels from col. 1{==} to col. 10{==} are {54/24,27/12,54/24,27/12,54/24,54/24,27/12,/54/24,27/12};

Detailed description of embodiment 1 of configuring Left rotation Wormhole mode:

As FIG. 2, The 1) of the step S2 as in FIG. 1: S2 configure new String Supermode according to a mode-instruction: 1)set basic parameters of String Supermode: 1.1) divide the roadnet area into [symbol] -type subareas, denoted by 2{(5,0),(4,4)} as label 9, representing the 2^{nd} subarea and its scope ranging from its origin coordinates (5,0) to upper 4 rows, to right 4 columns, other 3 subareas are 1{(0,0),(4,4)}, 3{(5,5),(4,4)}, 4{(0,5),(4,4)}, total 4 subareas, 1.2) for the time being no redistribution of the period, limit speed based on the above features, 1.3) for the time being no set showing devices for limit speed, countdown timer, change-speed including guideboard, vehicle navigator, autopilot system, mobile phone, etc,

### 2) Configure the Left Rotation Wormhole Mode in Every Subarea:

2.1) determine the origin positions of the IDEN-Lead modes in 4 subareas of Left rotation greenwaves:
master/slave direction, Lead/Jam-Relief function, the channels and their start-intersections of master/slave direction time-offset setting,
subarea 1, \textcircled{1}master/slave directions: South/East, \textcircled{2}Lead greenwave, \textcircled{3}the mode's origin: Q1(0,4),
subarea 2, \textcircled{1}master/slave directions: East/North, \textcircled{2}Lead greenwave, \textcircled{3}the mode's origin:Q2(5,0),
subarea 3, \textcircled{1}master/slave directions: North/West, \textcircled{2}Lead greenwave, \textcircled{3}the mode's origin: Q3(9,5),
subarea 4, \textcircled{1}master/slave directions: West/South, \textcircled{2}Lead greenwave, \textcircled{3}the mode's origin:Q4(4,9), the master/slave directions of 4 subareas as shown in the FIG. 2.2) calculate the time-offsets and its interim period of every intersection of every subarea of Lead 2D greenwave mode and configure the interim period, the configuration as follows: subarea 1
\textcircled{1} determine the traffic-time of time-offset: Lead mode uses set-drive-time,
\textcircled{2} master direction channels' set of time-offsets: South 1 to South 5 {72,48,36,12,0},
\textcircled{3} slave direction configuration channel: East 5's intersection set {(0,4), (1,4), (2,4), (3,4), (4,4)}, its set of greenwave time-offsets: {0,12,24,36,48,72},
\textcircled{4} Lead mode's time-offset, \textcircled{5} their remainders and interim-periods:

South 5 {*}={72+72,48+72,36+72,12+72,0+72}mod(60)={24,0,48,24,12},

South 4 {*}={72+60,48+60,36+60,12+60,0+60}mod(60)={12,48,36,12,0},

South 3 {*}={72+36,48+36,36+36,12+36,0+36}mod(60)={48,24,12,48,36},

South 2 {*}={72+24,48+24,36+24,12+24,0+24}mod(60)={36,12,0,36,24},

South 1 {*}={72+0,48+0,36+0,12+0,0+0}mod(60)={12,48,36,12,0},
Concrete to an intersection, for an example, hereinafter, the coordinates (i,j) are relative to the origin (0,0) of their subarea,

South 3 channel's 4^{th} intersection is (2,3), its time-offset and remainder=([12]+[36])mod(60)=48,

South 5 channel's 1^{st} intersection is (4,4), its time-offset and remainder=([0]+[72])mod(60)=12;
\textcircled{6} the wave-initial interim-period: the remainders 12 of intersection (0,0), (0,3), (1,1), (2,2), (3,0), (3,3), (4,4) are too small, made an expanding red light time, the other intersections' time-offsets are divided into East/West permit time plus South/North permit time making a signal period, denoted by #+#, obtain the wave-initial interim-period:

South 5 {*}={12+12,0,24+24,12+12,12},

South 4 {*}={12,24+24,18+18,12,0},

South 3 {*}={24+24,12+12,12,24+24,18+18},

South 2 {*}={18+18,12,0,18+18,12+12},

South 1 {*}={12,24+24,18+18,12,0};
subarea 2: master/slave directions:East/North, channel # and intersections' coordinates are relative to the origin (5,0) of their subarea,
\textcircled{1} determine the traffic-time of time-offset: Lead mode uses set-drive-time,
\textcircled{2} master direction channels' set of time-offsets: East 1 to East 5 {0,12,36,60,72},
\textcircled{3} slave direction configuration channel: North 5's intersection set {(5,0), (5,1), (5,2), (5,3), (5,4)}, its set of greenwave time-offsets: {0,24,36,60,72},
\textcircled{4} Lead mode's time-offset, \textcircled{5} their remainders and interim-periods:

South 5 {*}={0+72,12+72,36+72,60+72,72+72} mod(60)={12,24,48,12,24},

South 4 {*}={0+60,12+60,36+60,60+60,72+60} mod(60)={0,12,36,0,12},

South 3 {*}={0+36,12+36,36+36,60+36,72+36} mod(60)={36,48,12,36,48},

South 2 {*}={0+24,12+24,36+24,60+24,72+24} mod(60)={24,36,0,24,36},

South 1 {*}={0+0,12+0,36+0,60+0,72+0} mod(60)={0,12,36,0,12},
Concrete to an intersection, the coordinates (i,j) are relative to the origin (5,0) of their subarea,

South 3 channel's 2^{nd} intersection is (1,2), its time-offset and remainder=([12]+[36])mod(60)=48,

South 5 channel's 5^{th} intersection is (4,4), its time-offset and remainder=([72]+[72])mod(60)=24;
\textcircled{6} the wave-initial interim-period: the remaiders 12 of intersection (1,0), (4,0), (2,2), (1,3), (4,3), (0,4), (3,4) are too small, made an expanding red light time, the other intersections' time-offsets are divided into East/West permit time plus South/North permit time making a signal period, denoted by #+#, obtain the wave-initial interim-period:
subarea 3: master/slave directions:North/West, channel# and intersections' coordinates are relative to the origin (5,5) of their subarea,
\textcircled{1} determine the traffic-time of time-offset: Lead mode uses set-drive-time,
\textcircled{2} master direction channels' set of time-offsets: North 1 to North 5 {0,24,36,60,72},
\textcircled{3} slave direction configuration channel: West 5's intersection set {(5,5), (6,5), (7,5), (8,5), (9,5)}, its set of greenwave time-offsets: {72,60,36,24,0},
\textcircled{4} Lead mode's time-offsets, \textcircled{5} their remainders and interim-periods:

North 5 {*}={0+72,24+72,36+72,60+72,72+72} mod(60)={12,36,48,12,24},

North 4 {*}={0+60,24+60,36+60,60+60,72+60} mod(60)={0,24,36,0,12},

North 3 {*}={0+36,24+36,36+36,60+36,72+36} mod(60)={36,0,12,36,48},

North 2 {*}={0+24,24+24,36+24,60+24,72+24} mod(60)={24,48,0,24,36},

North 1 {*}={0+0,24+0,36+0,60+0,72+0} mod(60)={0,24,36,0,12},
Concrete to an intersection, the coordinates (i,j) are relative to the origin (5,5) of their subarea,

North 3 channel's 2^{nd} intersection is (2,1), its time-offset and remainder=([24]+[36])mod(60)=0,

North 5 channel's 5^{th} intersection is (4,4), its time-offset and remainder=([72]+[72])mod(60)=24;
\textcircled{6} the wave initial interim period: the remaiders 12 of intersection (4,0), (2,2), (4,3), (0,4), (3,4) are too small, made an expanding red light time, the other intersections' time-offsets are divided into East/West permit time plus South/North permit time making a signal period, denoted by #+#, obtain the wave-initial interim-period:
subarea 4: master/slave directions:West/South, channel# and intersections' coordinates are relative to the origin (0,5) of their subarea,
\textcircled{1} determine the traffic-time of time-offset: Lead mode uses set-drive-time,
\textcircled{2} master direction channels' set of time-offsets: West 1 to West 5 {72,48,36,12,0},
\textcircled{3} slave direction configuration channel: South 5's intersection set {(4,5), (4,6), (4,7), (4,8), (4,9)}, its set of greenwave time-offsets: {72,48,36,12,0},
\textcircled{4} Lead mode's time-offset, \textcircled{5} their remainders and interim periods:

North 5 {*}={72+0,48+0,36+0,12+0,0+0}mod(60)={12,48,36,12,0},

North 4 {*}={72+12,48+12,36+12,12+12,0+12}mod(60)={24,0,48,24,12},

North 3 {*}={72+36,48+36,36+36,12+36,0+36}mod(60)={48,24,12,48,36},

North 2 {*}={72+48,48+48,36+48,12+48,0+48}mod(60)={0,36,24,0,48},

North 1 {*}={72+72,48+72,36+72,12+72,0+72}mod(60)={24,0,48,24,12},
Concrete to an intersection, the coordinates (i,j) are relative to the origin (0,5) of their subarea, West 3 channel's 2^{nd} intersection is (1,2), its time-offset and remainder=([48]+[36])mod(60)=24, West 5 channel's 5^{th} intersection is (4,4), its time-offset and remainder=([0]+[0])mod(60)=0;
\textcircled{6} the wave-initial interim-period: the remaiders 12 of intersection (4,0), (2,2), (4,3), (0,4), (3,4) are too small, made an expanding red light time, the other intersections' time-offsets are divided into East/West permit time plus South/North permit time making a signal period, denoted by #+#, obtain the wave-initial interim-period:

Detailed description of embodiment 2 of configuring Shunting Centipede mode:

As FIG. 7, The 1) of the step S2 as in FIG. 1: S2 configure Shunting Centipede according to a String Supermode indtruction: 1)set basic parameters of String Supermode: 1.1) divide the roadnet area into [symbol] / [symbol] -type subareas, denoted by 2 {(5,0),(4,9)}, representing the 2^{nd} subarea and its scope ranging from its origin coordinates (5,0) to upper 9 rows, to right 4 columns, the other subarea are 1 {(0,0),(4,9)}, total 2 subareas, 1.2) for the time being no redistribution of the period,limit speed based on the above features, 1.3) for the time being no set showing devices for limit speed, countdown timer, change-speed including guideboard, vehicle navigator, autopilot system, mobile phone, etc, then
2) configure the Shunting Centipede mode from String Supermode indtruction :
2.1) determine the origin positions of the IDEN-Lead modes in 2 subareas: South/North is master, subarea 1, \textcircled{1} master/slave directions: South/West, \textcircled{2} Lead greenwave, \textcircled{3} the mode's origin:Q1(4,9), subarea 2, \textcircled{1} master/slave directions: North/East, \textcircled{2} Lead greenwave, \textcircled{3} the mode's origin:Q2(5,0), the master/slave directions of 2 subareas as shown in the FIG.
2.2) calculate the time-offsets and its interim-period of every intersection of every subarea of Lead 2D greenwave mode and configure the interim period, the configuration as follows:
subarea 1: master/slave directions: South/West, the intersections' coordinates and channels'# are relative to the intersection(0.0);
\textcircled{1} determine the traffic-time of time-offset: Lead mode uses set-drive-time,
\textcircled{2} master direction channels' set of time-offsets:
South 1 to South 5 {168,144,132,108,96,72,48,36,12,0}mod(60)={48,24,12,48,36,12,48,36,12,0},
\textcircled{3} slave direction configuration channel: West 9's intersection set {(0,9), (1,9), (2,9), (3,9), (4,9)}, its set of greenwave time-offsets: {72, 48, 36, 12, 0}mod(60)={12, 48, 36, 12, 0},
\textcircled{4} Lead mode's time-offset, \textcircled{5} their remainders and interim periods:

$$\begin{matrix}\begin{matrix}\{ * \} = \{ 48 + 0 , 24 + 0 , 12 + 0 , 48 + 0 , 36 + 0 , 12 + 0 , \\ 48 + 0 , 36 + 0 , 12 + 0 , 0 + 0 \} mod ( 60 ) \\ = \{ 48 , 24 , 12 , 48 , 36 , 12 , 48 , 36 , 12 , 0 \} ,\end{matrix} & South 5 \\ \begin{matrix}\{ * \} = \{ 48 + 12 , 24 + 12 , 12 + 12 , 48 + 12 , 36 + 12 , 12 + 12 , \\ 48 + 12 , 36 + 12 , 12 + 12 , 0 + 12 \} mod ( 60 ) \\ = \{ 0 , 36 , 24 , 0 , 48 , 24 , 0 , 48 , 24 , 12 \} ,\end{matrix} & South 4 \\ \begin{matrix}\{ * \} = \{ 48 + 36 , 24 + 36 , 12 + 36 , 48 + 36 , 36 + 36 , 12 + 36 , \\ 48 + 36 , 36 + 36 , 12 + 36 , 0 + 36 \} mod ( 60 ) \\ = \{ 24 , 0 , 48 , 24 , 12 , 48 , 24 , 12 , 48 , 36 \} ,\end{matrix} & South 3 \\ \begin{matrix}\{ * \} = \{ 48 + 48 , 24 + 48 , 12 + 48 , 48 + 48 , 36 + 48 , 12 + 48 , \\ 48 + 48 , 36 + 48 , 12 + 48 , 0 + 48 \} mod ( 60 ) \\ = \{ 36 , 12 , 0 , 36 , 24 , 0 , 36 , 24 , 0 , 48 \} ,\end{matrix} & South 2 \\ \begin{matrix}\{ * \} = \{ 48 + 12 , 24 + 12 , 12 + 12 , 48 + 12 , 36 + 12 , 12 + 12 , \\ 48 + 12 , 36 + 12 , 12 + 12 , 0 + 12 \} mod ( 60 ) \\ = \{ 0 , 36 , 24 , 0 , 48 , 24 , 0 , 48 , 24 , 12 \} ,\end{matrix} & South 1\end{matrix}$$

Concrete to an intersection, for an example, hereinafter, the coordinates (i,j) are relative to the origin (0,0) of their subarea,
South 3 channel's 2^{nd} intersection is (2,1), its time-offset and remainder=([24]+[36])mod(60)=0,
South 5 channel's 5^{th} intersection is (4,4), its time-offset and remainder=([36]+[0])mod(60)=36;
\textcircled{6} the wave-initial interim-period: the remaiders 12 of intersection (1,1), (2,3), (2,6), (3,9), (4,3), (4,5), (4,8) are too small, made an expanding red light time, the other intersections' time-offsets are divided into East/West permit time plus South/North permit time making a signal period, denoted by #+#, obtain the wave-initial interim-period:

South 5 {*}={24+24, 12+12, 12, 24+24, 18+18, 12, 24+24, 18+18, 12, 0},

South 4 {*}={0, 18+18, 12+12, 0, 24+24, 12+12, 0, 24+24, 12+12, 12},

South 3 {*}={12+12, 0, 24+24, 12+12, 12, 24+24, 12+12, 12, 24+24, 18+18},

South 2 {*}={18+18, 12, 0, 18+18, 12+12, 0, 18+18, 12+12, 0, 24+24},

South 1 {*}={0, 18+18, 12+12, 0, 24+24, 12+12, 0, 24+24, 12+12, 12};
subarea 2: master/slave directions:North/East, channel# and intersections' coordinates are relative to the origin (5,0) of their subarea,
\textcircled{1} determine the traffic-time of time-offset: Lead mode uses set-drive-time,
\textcircled{2} master direction channels' set of time-offsets:
North 1 to North 5 {0, 24, 36, 60, 72, 96, 120, 132, 156, 168}mod(60)={0, 24, 36, 0, 12, 36, 0, 12, 36, 48},
\textcircled{3} slave direction configuration channel: East 9's intersection set {(5,0), (6,0), (7,0), (8,0), (9,0)}, its set of greenwave time-offsets: {0, 12, 36, 60, 72}mod(60)={0, 12, 36, 0, 12},
\textcircled{4} Lead mode's time-offset, \textcircled{5} their remainders and interim-periods:

$$\begin{matrix}\begin{matrix}\{ * \} = \{ 0 + 12 , 24 + 12 , 36 + 12 , 0 + 12 , 12 + 12 , 36 + 12 , \\ 0 + 12 , 12 + 12 , 36 + 12 , 48 + 12 \} mod ( 60 ) \\ = \{ 12 , 36 , 48 , 12 , 24 , 48 , 12 , 24 , 48 , 0 \} ,\end{matrix} & North 5 \\ \begin{matrix}\{ * \} = \{ 0 + 0 , 24 + 0 , 36 + 0 , 0 + 0 , 12 + 0 , 36 + 0 , \\ 0 + 0 , 12 + 0 , 36 + 0 , 48 + 0 \} mod ( 60 ) \\ = \{ 0 , 24 , 36 , 0 , 12 , 36 , 0 , 12 , 36 , 48 \} ,\end{matrix} & North 4 \\ \begin{matrix}\{ * \} = \{ 0 + 36 , 24 + 36 , 36 + 36 , 0 + 36 , 12 + 36 , 36 + 36 , \\ 0 + 36 , 12 + 36 , 36 + 36 , 48 + 36 \} mod ( 60 ) \\ = \{ 36 , 0 , 12 , 36 , 48 , 12 , 36 , 48 , 12 , 24 \} ,\end{matrix} & North 3 \\ \begin{matrix}\{ * \} = \{ 0 + 12 , 24 + 12 , 36 + 12 , 0 + 12 , 12 + 12 , 36 + 12 , \\ 0 + 12 , 12 + 12 , 36 + 12 , 48 + 12 \} mod ( 60 ) \\ = \{ 12 , 36 , 48 , 12 , 24 , 48 , 12 , 24 , 48 , 0 \} ,\end{matrix} & North 2 \\ \begin{matrix}\{ * \} = \{ 0 + 0 , 24 + 0 , 36 + 0 , 0 + 0 , 12 + 0 , 36 + 0 , \\ 0 + 0 , 12 + 0 , 36 + 0 , 48 + 0 \} mod ( 60 ) \\ = \{ 0 , 24 , 36 , 0 , 12 , 36 , 0 , 12 , 36 , 48 \} ,\end{matrix} & North 1\end{matrix}$$

Concrete to an intersection, the coordinates (i,j) are relative to the origin (5,0) of their subarea,
North 3 channel's 2^{nd} intersection is (2,1), its time-offset and remainder=([24]+[36])mod(60)=0,
North 5 channel's 5^{th} intersection is (4,4), its time-offset and remainder=([12]+[12])mod(60)=24;
\textcircled{6} the wave-initial interim-period: the remaiders 12 of intersection (1,1), (2,3), (2,6), (3,9), (4,3), (4,5), (4,8) are too small, made an expanding red light time, the other intersections' time-offsets are divided into East/West permit time plus South/North permit time making a signal period, denoted by #+#, obtain the wave-initial interim-period;

Detailed description of embodiment 3 of configuring 85-Pulsar mode:

As FIG. 8, The 1) of the step S2 as in FIG. 1: 1.1) no divide the roadnet area, 1.3) set showing devices for limit speed, countdown timer, change-speed including guideboard, vehicle navigator, autopilot system, as label 1 in FIG. 8, the detail of the 1.2) redistribute the signal-period that supports 2-way greenwaves in omni directions : 1.2.1)configure the maximum loss λ max<15% of 2-way greenwave in 4-direction: \textcircled{1} calculate λ max and T: group road-segments according to their lengths: 2 groups are longer, 10×570 m, 10×580 m, their average length D2, the others shorter, their average length D1, calculate: roadnet{10,10}, total road-segments n of all row and column channels, n=10*9+10+9=180,

D1=(Σdk)/(n−20)=51000/160=281.5,

D2=(10*570+10*580)/20=575, 575mod(282)/282≈11/282=4%<15%, ok,

The 1^{st} scheme: set greenwave speed per-hour v1 for vehicles, v1=36 km/h(equal to speed per-second 10 m/sec), average time-offset T1/D1/v1=28.2, average time-offset T2/D2/v1=57.5, the maximum loss λ max of the greenwave:

λmax1= [symbol] Tmax1/T1= [symbol] Dmax1/v1/T1= [symbol] Dmax1/D=32.5/281.5=11.5%,

insert D2 group to calculate: D=(Σdk)/(n+20)=(45000+11500)/200 =282.5,

λmax= [symbol] Dmax/D=11.5%, the λ max meets the requirement, T/D/v1=283/10=28.3,

Another scheme: set another speed v2=70km/h for the group of the longer road-segments to meet b % requirement for the λ max of T1: v2=70 (km/h)=19.4 (m/sec), T2=D2/v2=29.6 sec, take T=28, because T serves road-segments more than T2;
1.2.2) based on average set-drive-time T that meets the error 15% requirement of their max, determine the period C=2*T=2*28=56;
2) configure the IDEN-Lead mode in the roadnet area: select a direction as master direction,
2.1)deteremine the origin position of 2-way IDEN-Lead mode
\textcircled{1} master direction-East, slave direction-North, \textcircled{2} Lead greenwave, \textcircled{3} the mode's origin coordinates (0,0), as FIG.
2.2)calculate and configure the intersection's time-offsets and its wave-initial interim-period of 2-way IDEN-Lead mode, according to same speed v1=10 m/sec, the results as follows:
\textcircled{1} determine the traffic-time of time-offset: Lead mode uses set-drive-time,
\textcircled{2} master direction channels' set of intersection's time-offsets:
East 1 to East 10 {0, 30, 55, 85, 113, 171, 196, 226, 256, 284}mod(56)={0, 30, 55, 29, 1, 3, 28, 2, 32, 4},
\textcircled{3} slave direction configuration channel: North 1's intersection set {(0,0), (0,1), (0,2), (0,3), (0,4), (0,5), (0,6), (0,7), (0,8), (0,9)}, its set of 2-way greenwave time-offsets: {0, 30, 55, 85, 113, 170, 200, 225, 255, 283 }mod(60)={0, 30, 55, 29, 1, 2, 32, 1, 31, 3},
\textcircled{4} the 2-way IDEN-Lead time-offsets, \textcircled{4} their remainders and wave-initial interim-period: (take remainder with mod,then take sum):

$$\begin{matrix}\begin{matrix}\{ * \} = \{ 0 + 3 , 30 + 3 , 55 + 3 , 29 + 3 , 1 + 3 , 3 + 3 , 28 + 3 , 2 + 3 , \\ 32 + 3 , 4 + 3 \} mod ( 56 ) \\ = \{ 3 , 33 , 2 , 32 , 4 , 6 , 31 , 5 , 35 , 7 \} ,\end{matrix} & East 10 \\ \begin{matrix}\{ * \} = \{ 0 + 31 , 30 + 31 , 55 + 31 , 29 + 31 , 1 + 31 , 3 + 31 , \\ 28 + 31 , 2 + 31 , 32 + 31 , 4 + 31 \} mod ( 56 ) \\ = \{ 31 , 5 , 30 , 4 , 32 , 34 , 3 , 33 , 7 , 35 \} ,\end{matrix} & East 9 \\ \begin{matrix}\{ * \} = \{ 0 + 1 , 30 + 1 , 55 + 1 , 29 + 1 , 1 + 1 , 3 + 1 , \\ 28 + 1 , 2 + 1 , 32 + 1 , 4 + 1 \} mod ( 56 ) \\ = \{ 1 , 31 , 0 , 30 , 2 , 4 , 29 , 3 , 33 , 5 \} ,\end{matrix} & East 8 \\ \begin{matrix}\{ * \} = \{ 0 + 32 , 30 + 32 , 55 + 32 , 29 + 32 , 1 + 32 , 3 + 32 , \\ 28 + 32 , 2 + 32 , 32 + 32 , 4 + 32 \} mod ( 56 ) \\ = \{ 32 , 6 , 31 , 5 , 33 , 35 , 4 , 34 , 8 , 36 \} ,\end{matrix} & East 7 \\ \begin{matrix}\{ * \} = \{ 0 + 2 , 30 + 2 , 55 + 2 , 29 + 2 , 1 + 2 , 3 + 2 , \\ 28 + 2 , 2 + 2 , 32 + 2 , 4 + 2 \} mod ( 56 ) \\ = \{ 2 , 32 , 1 , 31 , 3 , 5 , 30 , 4 , 34 , 6 \} ,\end{matrix} & East 6 \\ \begin{matrix}\{ * \} = \{ 0 + 1 , 30 + 1 , 55 + 1 , 29 + 1 , 1 + 1 , 3 + 1 , \\ 28 + 1 , 2 + 1 , 32 + 1 , 4 + 1 \} mod ( 56 ) \\ = \{ 1 , 31 , 0 , 30 , 2 , 4 , 29 , 3 , 33 , 5 \} ,\end{matrix} & East 5 \\ \begin{matrix}\{ * \} = \{ 0 + 29 , 30 + 29 , 55 + 29 , 29 + 29 , 1 + 29 , 3 + 29 , \\ 28 + 29 , 2 + 29 , 32 + 29 , 4 + 29 \} mod ( 56 ) \\ = \{ 29 , 3 , 28 , 2 , 30 , 32 , 1 , 31 , 5 , 33 \} ,\end{matrix} & East 4 \\ \begin{matrix}\{ * \} = \{ 0 + 55 , 30 + 55 , 55 + 55 , 29 + 55 , 1 + 55 , 3 + 55 , \\ 28 + 55 , 2 + 55 , 32 + 55 , 4 + 55 \} mod ( 56 ) \\ = \{ 55 , 29 , 54 , 28 , 0 , 2 , 27 , 1 , 31 , 3 \} ,\end{matrix} & East 3 \\ \begin{matrix}\{ * \} = \{ 0 + 30 , 30 + 30 , 55 + 30 , 29 + 30 , 1 + 30 , 3 + 30 , \\ 28 + 30 , 2 + 30 , 32 + 30 , 4 + 30 \} mod ( 56 ) \\ = \{ 30 , 4 , 29 , 3 , 31 , 33 , 2 , 32 , 6 , 34 \} ,\end{matrix} & East 2 \\ \begin{matrix}\{ * \} = \{ 0 + 0 , 30 + 0 , 55 + 0 , 29 + 0 , 1 + 0 , 3 + 0 , \\ 28 + 0 , 2 + 0 , 32 + 0 , 4 + 0 \} mod ( 56 ) \\ = \{ 0 , 30 , 55 , 29 , 1 , 3 , 28 , 2 , 32 , 4 \} ,\end{matrix} & East 1\end{matrix}$$

Concrete to an intersection, for an example, the coordinates (i,j) are relative to the area origin (0,0),
East 3 channel's 2^{nd} intersection is (1,2), its time-offset and remainder=([30]+[55])mod(56)=29,
East 5 channel's 5^{th} intersection is (4,4), its time-offset and remainder=([1]+[1])mod(56)=2;
\textcircled{6} the wave-initial interim-period: the remaiders 20 of intersectionsare too small, made an expanding red light time, the other intersections' time-offsets are divided into East/West permit time plus South/North permit time making a signal period, denoted by #+#, obtain the wave-initial interim-period;

What is claimed as new and desired to be protected by Letters Patent is set forth in the following:

1. A method for a String SuperMode used in road traffic signal network includes steps:
S1: Set RATIO as initial state with obtaining the length and traffic-times of every road-segment of a roadnet;
S2 calculate and configure new String Supermode according to a String Supermode instruction: 1) set the basic parameters: 1.1) divide the roadnet area of intersections into several subareas, 1.2) or redistribute period and speed limit according to the features of road-segments, 1.3) or equip signal devices for limit speed, countdown timer, change-speed including guideboard, vehicle navigator, mobile communication equipment or autopilot system, etc; 2) configure the 2D mode of greenwave in each said subarea of the String Supermode structure, said 2D mode of greenwave including IDEN-Lead mode, IDEN-Jam-Relief mode, DIFF mode, etc, the combination of the origins' positions and their master directions of 2D mode in said subareas determine the class of String SuperModes, vice-verse , 2.1) determine the position of the origin of instructed 2D mode of every subarea: an intersection at a corner in a subarea, \textcircled{1} determine master/slave directions, \textcircled{2} determine Lead/Jam-Relief greenwave, \textcircled{3} get the position of an origin and the configuring channels of 2D greenwave time-offsets and their strat-intersections: for 2D Lead mode of greenwaves, i.e. IDEN-Lead mode, its origin is the intersection of the most upstream intersection both of master direction and of slave one, the start-intersection from where every master direction channel's every intersection's greenwave time-offset is calculated is its channel most upstream intersection, the configuring channel of slave greenwave time-offsets is composed of the start-intersections of master direction channels and its start-intersection is the above origin; for 2D Jam-Relief mode of greenwaves, i.e. IDEN-Jam-Relief mode, its origin is the intersection of the most downstream intersection both of master direction and of slave one, the start-intersection from where every master direction channel's every intersection's greenwave time-offset is calculated is its channel most downstream intersection, the configuring channel of slave greenwave time-offsets is composed of the start-intersections of master direction channels and its start-intersection is the above origin; for 2D Lead and Jam-Relief mode of greenwaves, i.e. DIFF-mix mode, its origin is the intersection both of the most upstream intersection of Led direction and of the most downstream intersection of Jam-Relieved direction, the start-intersection from where every led direction channel's every intersection's master greenwave time-offset is calculated is its channel most upstream intersection, the configuring channel of slave greenwave time-offsets is composed of the start-intersections of master direction channels and its start-intersection is the above origin, and for 2D Jam-Relief and Lead mode, i.e., the master-Lead direction and slave-Jam-Relief exchange of DIFF-mix mode: and also the master-Jam-Relief direction and slave-Lead direction; 2.2)calculate the greenwave time-offsets of every intersection and configure its interim period: \textcircled{1} determine the traffic-time of the time-offsets of every road-segment, Lead mode uses set-drive-times to sum, Lead mode uses JVQ-start-times to sum, \textcircled{2} calculate the time-offset t1 from its start-intersection of every intersection of a master channel, \textcircled{3} calculate the time-offset t2 from the origin intersection of every intersection of the slave time-offset configuring channel, \textcircled{4} add master time-offset t1 and slave tie-offset t2, get 2D mode time-offset t , \textcircled{5} obtain the period remainder of the 2D mode time-offset t, \textcircled{6} make the period remainder a signal interim period of every intersection: the remainder as time=North-South permit time+East-West permit time;
S3 run RATIO mode after running out the respective interim period of every intersection with red-light-on or without signals.

2. A method as defined in claim 1, wherein the 1.1) of step S2 includes the steps of:
S21 using straight lines divide a roadnet area of intersections into some subareas, obtain following types: 4 areas of [symbol] -type of [symbol] -division, [symbol] -type division, [symbol] -type division and [symbol] -type division, [symbol] -type division/ [symbol] -type division, etc, these divisions generally corresponds to the distributions of the intersections of a real roadnet, also to the configuration by softwares for the requirements of controlling traffic flows of roadnets, [symbol] -type of [symbol] -division is standard String Supermode division, is a basic optimized structure, absolute symmetry is not a must.

3. A method as defined in claim 1, wherein step S2 includes the steps of:
S22 said signal devices of showing to moving vehicles for limit speed, countdown timer, change-speed include guideboard, vehicle navigator, mobile communication equipment or autopilot system, etc, showing information includes the rest signal time, approaching minimum braking point/time/reducing speed, showing way includes words, phonetics, colors, patterns, etc., signals includes red lights or green lights; for an example, the time <5 of signals countdown timer, limit speed 36 km/h, its braking time/distance are 3 sec/15 meters or so, at about 20 meters show the information for reducing speed, in words, phonetics, colors, patterns, etc., signals includes red lights or green lights.

4. A method as defined in claim 1, wherein step S2 includes the steps of:
S23 Configure a class called Wormhole of Said String Supermode from a String Supermode instruction: 1) divide a roadnet area using straight lines, obtain subareas, each of which subareas and their mother roadnet area share one and only one side; 2) configure each subarea as such a IDEN-Lead mode that its origin is at a side but not at a corner of the roadnet, and its master directions of subareas are organized clockwise rotation, called Right rotation Wormhole of String, and organized anticlockwise rotation, called Left rotation Wormhole of String.

5. A method as defined in claim 1, wherein step S2 includes the steps of:
S24 Configure a class called Blackhole of Said String Supermode from a String Supermode instruction: 1) divide a roadnet area using straight lines, obtain subareas, whose mother roadnet area and each of which subareas have one and only one side to share; 2) configure each subarea as such a IDEN-Lead mode that its origin is at both a corner of the subarea and a corner of the roadnet, and its master directions of subareas are organized clockwise rotation, called Right rotation Blackhole of String, and organized anticlockwise rotation, called Left rotation Blackhole of String.

6. A method as defined in claim 1, wherein step S2 includes the steps of:
S25 Configure a class called Whitehole of Said String Supermode from a String Supermode instruction: 1) divide a roadnet area using straight lines, obtain subareas, each of which subareas and their mother roadnet area share one and only one side; 2) configure each subarea as such a IDEN-Lead mode that its origin is neither at a side nor at a corner of the roadnet, and its master directions of subareas are organized clockwise rotation, called Right rotation Whitehole of String, and organized anticlockwise rotation, called Left rotation Whitehole of String.

7. A method as defined in claim 1, wherein step S2 includes the steps of:
S26 Configure a class called Redgiant of Said String Supermode from a String Supermode instruction: 1) divide a roadnet area using straight lines, obtain subareas, each of which subareas and their mother roadnet area share one and only one side; 2) configure each subarea as such a IDEN-Jam-Relief mode that its origin is both at a corner of a subarea and at a corner of the roadnet, and its master directions of subareas are organized clockwise rotation, called Right rotation Redgiant of String, and organized anticlockwise rotation, called Left rotation Redgiant of String.

8. A method as defined in claim 1, wherein step S2 includes the steps of:
S27 Configure a class called Whitedwarf of Said String Supermode from a String Supermode instruction: 1) divide a roadnet area using straight lines, obtain subareas, each of which subareas and their mother roadnet area share one and only one side; 2) configure each subarea as such a IDEN-Jam-Relief mode that its origin is neither at a side nor at a corner of the roadnet, and its master directions of subareas are organized clockwise rotation, called Right rotation Whitedwarf of String, and organized anticlockwise rotation, called Left rotation Whitedwarf of String.

9. A method as defined in claim 1, wherein step S2 includes the steps of:
S28 Configure a class called Centipede of Said String Supermode from a String Supermode instruction: 1) divide the roadnet mother area through with a straight line, obtain 2 subareas; 2) configure each subarea as such a IDEN-Lead mode that one of the 2 origins is at a corner of a subarea and a side of but not a corner of the roadnet, and the 2 origins are adjacent or opposite at the other end of the master channels whose one end is adjacent to the other origin, make the single master direction or 2 convection master directions, organized so-called Shunting Centipede of String, 2 adjacent origins can share one intersection; or, that the both origins are separately at a non-adjacent corner of the roadnet, organized so-called Conflux Centipede of String.

10. A method as defined in claim 1, wherein step S2 includes the steps of:
S29 Configure a class called b-Pulsar of Said String Supermode from a String Supermode instruction: 1.2) configure a Convection IDEN-Lead mode greenwave period: 1.2.1)configure the said mode whose maximum convection mode loss λ max is less than some percentage (1-b) %: λ max is the maximum absolute difference between a road-segment's set-drive-time and the average D of all road-segment's set-drive-times divided by the average D,.take the average time T of the set-drive-time in λ max<(1-b) %, T=D/v, v—set-drive-speed(meter/sec); 1.2.2)according to the average T that meets the error requirement λ max<(1-b) %, determine the period C=2*T.

11. A method as defined in claim 10, wherein the 1.2.1) of b-Pulsar includes the steps of:
S210 configure maximum convection mode loss λ max less than some percentage (1-b) %: \textcircled{1} calculate the λ max,and T: λ max= [symbol] Tmax/T= [symbol] Dmax/D, where [symbol] Tmax—the longest road-segment's set-drive-time minus the average drive-time, [symbol] Dmax—the longest road-segment minus the average road-segment, T—the average set-drive-time of all road-segments, T=D/v, D—the average length of all road-segments(meter)=(Σdk)/n, dk—the k-th road-segment length, v—set-greenwave-drive-speed, n—total number of road-segments including row-channels and column-channels, for a roadnet {M,N}, n=M*(M−1)+N*(N−1), \textcircled{2} if λ max is bigger than (1-b) %, then group road-segments based on the lengths' similarity degree of road-segments, if the average length of a group and the one of another group are integer multiples, based on \textcircled{1} calculate an equavilent length of the longer group first, then obtain λ max and its T, \textcircled{3}, if the average lengths of groups are not around integer multiples, design variable set-greenwave-drive-speed scheme: set a different set-greenwave-driv-speed v for each group of road-segments, calculate and configure λ max and its T.
